(19) United States
(12) Patent Application Publication
(10) Pub. No.: US 2004/0089742 A1
(43) Pub. Date: May 13, 2004

(54) Drywall texture gun

(76) Inventor: Louis A. Antonucci, Mission Viejo, CA (US)

Correspondence Address: ROY A. EKSTRAND, 3158 REDHILL AVE., STE 150, COSTA MESA, CA, 92626, US

(21) Appl. No.: 10/632,339

(22) Filed: Aug. 1, 2003

Related U.S. Application Data
(63) Continuation-in-part of application No. 10/206,546, filed on Jul. 26, 2002, now abandoned.

(51) Int. Cl. B05B 9/03

(52) U.S. Cl. 239/302

(57) ABSTRACT

A drywall texture gun, having a chamber spray head with a one-way check valve installed at a first end thereof to allow compressed air flowing therein, a nozzle connected to a second end of the chamber spray head, and a supply tube extending across the chamber spray head with an inlet entering a texture supply and an outlet entering the nozzle. The outlet is restricted in the nozzle with an adjustable space to reciprocate responsive to the compressed air. Further, the outlet is so structured that the compressed air is introduced from the chamber spray head to adjust a pattern of a texture flowing therethrough. The inlet is so structured that the compressed air is able to flow from the chamber spray head to the texture supply to drive the texture into the tube. In an alternate embodiment, a compressed air gun is joined to the chamber spray head and includes a trigger assembly. An air bleed mechanism responds to the trigger during shut off to bleed off existing gun pressure.

### CROSS-REFERENCE OF RELATED APPLICATION

This application is a continuation-in-part of copending application Ser. No. 10/206,546 filed Jul. 26, 2002 on behalf of the applicant of this application which is entitled DRYWALL TEXTURE GUN.

### FIELD OF THE INVENTION

This invention relates generally to a texture gun, and more particularly, to a modular texture gun utilized for drywall finishing to achieve either an aesthetic effect or acoustical effect.

### BACKGROUND OF THE INVENTION

In the construction of a building, texture is applied over a drywall to form a textured wall surface. A variety of textures may be used to acquire aesthetic or acoustical effects. For the purpose of acquiring the aesthetic effect, the material for texturing is often referred as “mud”, which is typically heavy, thick and particulate. In contrast, the material for texturing the wall or ceiling with the acoustic effect is normally lightweight acoustic material. Therefore, prior art machines for spraying particulate texture material normally have sufficient power to deliver the lightweight acoustic material; however, such prior art machines are normally heavy, bulky and difficult to transport to different working environments. In contrast, prior art machines designed for applying the lightweight acoustic material typically do not have the power to deliver the heavier texture material.

In conventional texture supply machines, the pattern of the texture is mainly determined by the size of the nozzle tip and the pressure applied therein. However, adjusting both parameters to obtain a required texture pattern is very time and cost consuming. Further, both prior art machines for supplying mud and for supplying lightweight material are difficult to be dissembled, such that thorough cleaning cannot be properly performed.

Therefore a substantial need in the art exists to provide a relatively portable texture supply machine which is capable to provide both the aesthetic and acoustic effects, and preferably, such machine being easily dissembled to allow thorough cleaning. In addition, there exists a need to provide an additional mechanism for providing quick and easy adjustment of texture patterns for the same nozzle.

### BRIEF SUMMARY OF THE INVENTION

The present invention provides a drywall texture gun, which can be used to apply both particulate texture material and lightweight acoustic material over a drywall or other surface. The texture gun is light and includes various components modularly connected together. Therefore, a thorough clean-up process is easily performed. Further, the replacement of individual components can be easily achieved with such modular construction. The drywall texture gun further provides a mechanism for changing the texture patterns with or without changing the nozzle and adjusting the pressure therein. Thus, more texture patterns can be provided by the same texture gun.

In one embodiment of the present invention, the drywall texture gun comprises a chamber spray head with a one-way check valve installed at a first end thereof to allow compressed air flowing therein. In an alternate embodiment of the present invention, a gun having a trigger assembly is coupled to a source of compressed air and joined to the chamber spray head. A nozzle is connected to a second end of the chamber spray head, and a tube extends across the chamber spray head. The tube has an inlet entering a texture supply and an outlet entering the nozzle. The outlet is restricted in the nozzle with an adjustable space to move back and forth responsive to the compressed air. Further, the outlet is so structured that the compressed air is introduced from the chamber spray head to break up the texture material flowing therethrough. The inlet is so structured that the compressed air is able to flow from the chamber spray head to the texture supply to drive the texture into the tube.

The drywall texture gun of the present invention further comprises a hollow body connected to the first end of the chamber spray head. A source of compressed air, either a hand pump or a compressed air gun is connected to the second end. A nozzle seat is joined to the chamber spray head and adjustably supports the nozzle. The tube has a dimension smaller than a gauge of the nozzle seat, such that the compressed air can flow from the chamber spray head to the nozzle. The chamber spray head has an opening at a sidewall thereof allowing the tube to extend to the texture supply. The opening is larger than a dimension of the tube, such that the compressed air can flow from the chamber spray head in to the texture supply. The outlet has a protruded structure at a perimeter thereof to restrict the outlet in the nozzle, and at least one hole at a perimeter thereof, such that the compressed air flowing from the chamber spray head can enter the tube at the outlet to break up the texture material therein.

The above components, including the hollow body, the chamber spray head, the check valve the nozzle and the tube are formed as individual modules that are easily assembled and disassembled from each other. Therefore, the replacement for any of the components is simple, and consequently, the texture gun can be rapidly and easily cleaned. In addition, the structure of the outlet of the tube for transporting texture, responsive to the compressed air, allows an additional quick and easy adjustment of the texture pattern. In addition, the spray gun compressor embodiment of the invention includes a trigger-actuated pressure chamber pressure bleed to terminate material flow when the trigger is released.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 shows a perspective view of the texture gun provided by the present invention;

FIG. 2 shows the exploded view of the texture gun provided by the present invention;

FIG. 3 shows a cross-sectional view of the texture gun provided by the present invention;

FIG. 4 sets forth a partial perspective view of the locking feature of the present invention texture gun;

FIG. 5 sets forth a partial section view of the material tube of the present invention texture gun;

FIG. 6 sets forth a side elevation view of an alternate embodiment of the present invention texture gun;

FIG. 7 sets forth a bottom view of the texture gun shown in FIG. 6; and

FIGS. 8A and 8B shows partial section views of the trigger unit used in the present invention texture gun showing on and off trigger positions respectively.

### DETAILED DESCRIPTION OF THE INVENTION

FIG. 1 is a perspective view showing the external feature of the texture gun 10 in one embodiment of the present invention. In this embodiment, the texture gun 10 is connected with a hand pump 12. It will be appreciated that one of ordinary skill in the art may also use other pressure supply structures such as an air compressor as set forth in the alternate embodiment shown in FIG. 6 to achieve the similar effect without exceeding the scope of the present invention. The texture gun 10 comprises a nozzle 14, a chamber spray head 16, and hand pump 12 having a hollow tubular body 18. The chamber spray head 16 is threadably connected to one longitudinal end of hollow tubular body 18, while a plunger 13 is connected to a piston 15 within hollow tubular body 18. The chamber spray head 16 is further connected to the nozzle 14 along its longitudinal axis and a texture supply 20 along the direction substantially perpendicular to the longitudinal axis. Preferably, one side of plunger 13 is telescopically received within the hollow tubular body 18 and supports piston 15 to reciprocate piston 15 within the hollow tubular body 18, so as to introduce a pressure therein.

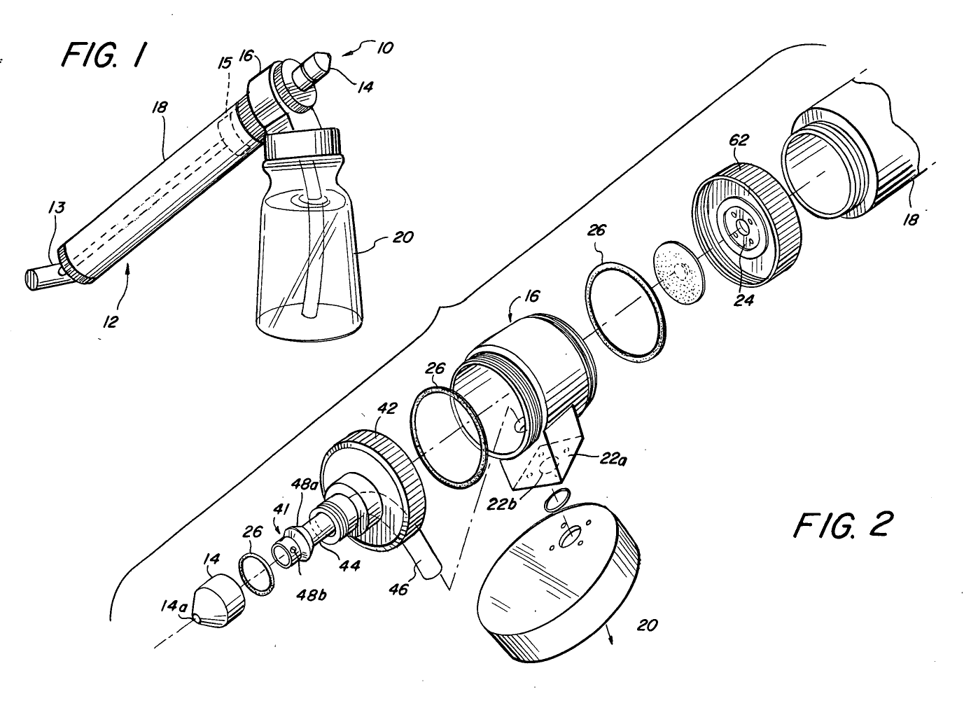

FIG. 2 shows an assembly view illustrating the modular construction of the texture gun 10. As shown FIG. 2, various parts, including the nozzle 14, then chamber spray head 16, the hollow tubular body 18, and other components such as a bezel member 22 to receive the texture supply 20, and a check valve 24 to be installed between the hollow tubular body 18 and the chamber spray head 16 can be removably mounted and detached from each other. By this modular construction, one can easily dissemble the texture gun for cleaning or changing any of the components or parts according to specific requirement. For example, when the volume or pattern for each droplet of texture is varied according to different specification, the nozzle 14 can be easily removed from the texture gun 10 and another nozzle with the required can be easily fixed. The bezel member 22 has an opening aligned with an opening at a bottom surface of the chamber spray head 16 to allow the compressed air and the texture to flow through.

The bezel member 22 has a flat lower surface 22a to be connected with a cap or a lid of the texture supply 20. A groove 22b is formed on the flat lower surface 22a, such that a flexible or elastic O-ring can be inserted therein for providing firm connection between the chamber spray head 16 and the cap of the texture supply 20. Various kinds of mechanisms can be applied for attaching the bezel member 22 to the texture suppl 20; or for attaching the texture supply 20 to the bezel member 22. In this example, several holes perforating the bezel member 22 and the lid of the texture supply 20 are formed. By aligning the holes, devices such as screws can be used to connect the chamber spray head 16 and the texture supply 20. Preferably, the bezel member 22 is integrally formed with the chamber spray head 16. It will be appreciated that the bezel member 22 can also be formed as an individual element and connected between the chamber spray head 16 and the texture supply 20 subsequently via any suitable mechanical structure.

Further referring to FIG. 2, the texture gun 10 comprises a nozzle seat 42 inserted between the chamber spray head 16 and the nozzle 14 to allow the nozzle 14 to be mounted on one side thereof and the chamber spray head 16 to be connected at the opposing side thereof. A connector 62 that carries the check valve 24 therein is positioned between the chamber spray head 16 and the hollow tubular body 18 of hand pump 12. In one embodiment of the present invention, threads are formed in corresponding positions of the nozzle 14, the chamber spray head 16 and the hollow tubular body 18 for connection. It is appreciated that other mechanical structures may also be applied to provide similar connection in the present invention. Preferably, O-rings 26 in various sizes are applied in peripheral grooves between the nozzle 14 and the nozzle seat 42, the nozzle seat 42 and chamber spray head 16, and the chamber spray head 16 and the hollow tubular body 18.

The texture gun 10 further comprises a supply tube 44 extending through the chamber spray head 16 and the nozzle seat 42 with an inlet 46 and an outlet 48 entering the texture supply and nozzle 14, respectively. The cross-sectional area of the supply tube 44 is slightly smaller than the inside diameter of the nozzle seat 42 and the above openings to allow compressed air supplied from the hollow tubular body 18 flowing into the nozzle 14 and the texture supply 20. Further, the outlet 48 of the tube 44 has a protruded perimeter 48a, i.e., increased diameter, to prevent the inlet 48 from the nozzle seat 42. Apertures 48a are formed between the opening of the outlet 48 and the protruded perimeter 48a to provide a path for the compressed air to flow through. The tip 14a of the nozzle 14 has an opening allowing the texture to be sprayed therefrom.

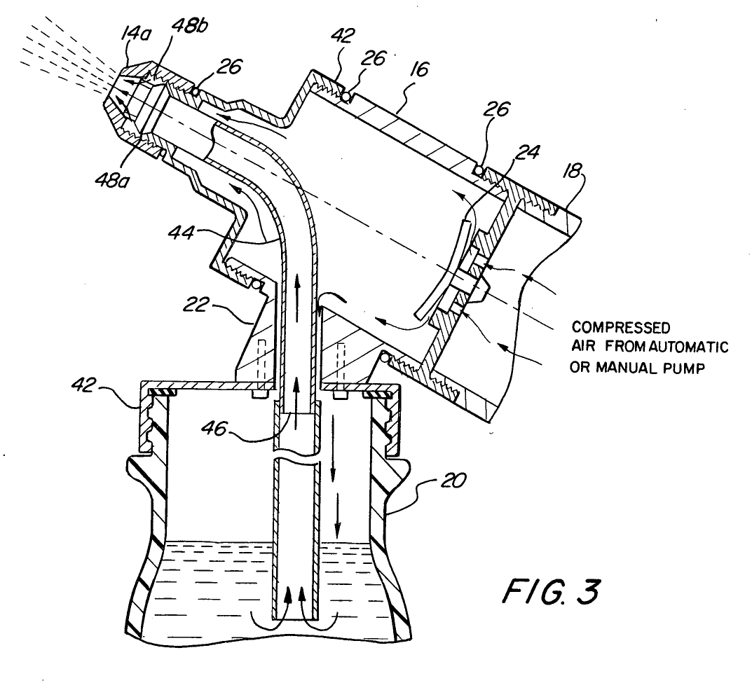

FIG. 3 shows the operation of the texture gun 10. The hollow tubular body 18 of hand pump 12 is connected to chamber spray head 16 by connector 62. Through the action of one-way check valve 24, the compressed air provided by hand pump 12 enters the chamber spray head 16 in only one direction; i.e., air or other fluid is prevented from flowing between the openings of the chamber spray head 16. The compressed air flows through the space between the openings of the chamber spray head 16 and the bezel member 22 and the tube 44; and then enters the texture supply 20. The texture material stored in the texture supply 20 thus experiences a downward pressure on its surface; and is consequently forced upwardly into the tube 44, and eventually, sprayed out of the texture gun 10 from the nozzle tip 14a.

As mentioned above, the nozzle 4 and nozzle seat 42 are connected with each by means of mechanical structure such as threads. As shown in FIG. 3, when the nozzle 14 is unthreaded away from the nozzle seat 42, a larger space is resulted for the outlet 48 to move back and forth between the nozzle 14 and the nozzle seat 42. The larger space allows more compressed air entering the nozzle 14. With the formation of holes 48b right before the opening of the outlet 48, the compressed air flows into outlet 48 to break up the texture material therein. In the preferred fabrication of the invention, apertures 48b are angled to better swirl air and break up texture material. As a result, the pattern of the texture sprayed out of the texture gun and its character are altered. In contrast, if the nozzle 14 is threaded toward the nozzle seat 42, the space for the inlet 48 moving back and forth, that is, the path allowing the compressed air to flow into the inlet 48 is smaller. Therefore, a lower pressure is applied to the texture at the outlet 48, and again, the texture pattern and material character are changed. The structure of the outlet 48 allows a quick adjustment of the compressed air right before the texture is sprayed from the nozzle tip 14a, such that the texture pattern can be easily and effectively adjusted.

Further, the gradually reduced size of nozzle tip 14a and the protruded perimeter 48a restrict the outlet 48 of the tube 44 in the nozzle 14, such that the tube 44 is securely positioned at all times during the texturing process. In addition to the adjustment of the position of the nozzle 14, the pressure of the compressed air may also determine the texture pattern. The path for the compressed air to affect the texture pattern is thus altered. Consequently, the texture pattern may be changed. In addition, the inlet 46, as shown in FIG. 3, can be extended by connecting an additional tube to allow the inlet 46 immersed in the texture. Or alternatively, a longer tube can be used.

As shown in FIGS. 1 to 3, the texture gun 10 provided by the present invention is relatively light compared to the conventional structure. The portability is thus greatly enhanced. Depending upon the switchable pressure supply and other modular component such as chamber spray head, nozzle, texture supply, both the mud and the lightweight acoustic material can be applied over the drywall using such texture gun. Further, the outlet of the texture supply channel, that is, the tube 44 as shown in FIG. 3, provides an additional mechanism to adjust the texture pattern.

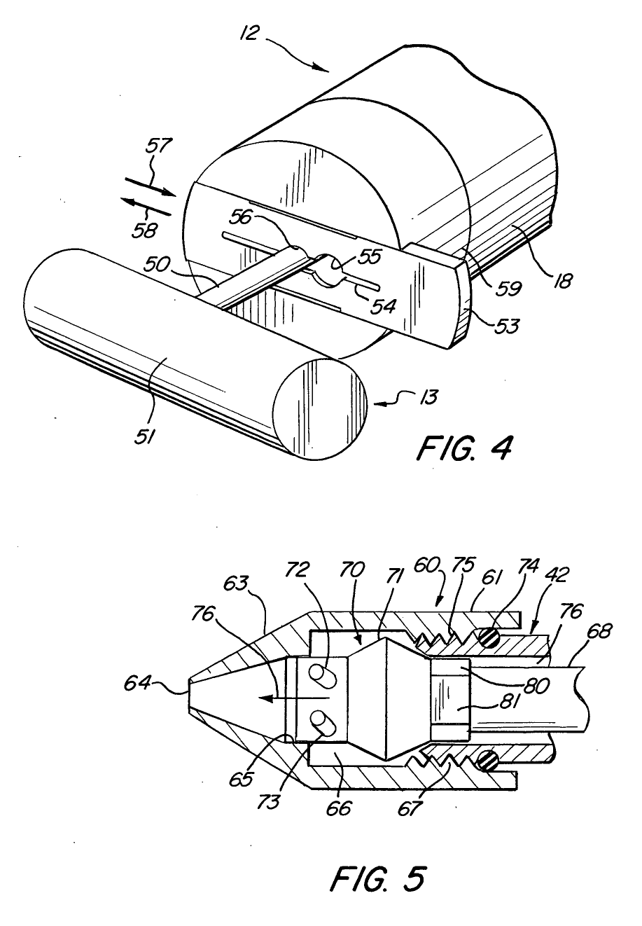

FIG. 4 sets forth a partial perspective view of a further alternate embodiment of the present invention texture material gun. In particular, FIG. 4 shows the end portion of hand pump 12 having tubular body 18 supporting an end cap 59 which is secured to tubular body 18 by threaded attachment. As described above, hand pump 12 includes a plunger 13 which is reciprocated with respect to tubular body 18 to provide a source a pressurized or compressed air for the present invention texture material gun. In particular, plunger 13 supports a piston 15 (seen in FIG. 1) upon a reciprocating pump rod 50. The outer end of pump rod 50 supports a handle 51. In typical use, handle 51 is moved back and forth along the axis of tubular body 18 to drive piston 15 in reciprocating motion within the tubular body and provide pressurized air through a check valve 24 (seen in FIG. 2) and thereby pressurize the supply within texture supply 20 (seen in FIG. 1). In accordance with the embodiment of the present invention shown in FIG. 4, end cap 59 defines a transverse channel 52 within which a slide lock 53 is supported. Slide lock 53 is secured within channel 52 such that sliding motion in the directions indicated by arrows 57 and 58 is facilitated while at the same time slide lock 53 is prevented from moving along with pump rod 50 as it reciprocates. Slide lock 53 defines a larger aperture 55 and a smaller overlapping aperture 56. Apertures 55 and 56 are sized such that aperture 55 allows pump rod 50 to move freely while aperture 56 is a tight interfering fit along pump rod 50. An elongated relief slot 54 is formed within slide lock 53 and extends on either side of apertures 55 and 56. Slot 54 allows flexing of slide lock 53 to accommodate pump rod 50.

In the position shown, slide lock 53 is in the engaging or lock position having been moved in the direction indicated by arrow 57. Accordingly, pump rod 50 is received within smaller aperture 56 in a tight fit. This tight fit secures pump rod 50 and prevents it from freely moving into or outwardly from the remainder of hand pump 12. Thus, the use of slide lock 53 in the locked position shown secures pump rod 50 in a desired position and prevents the annoying tendency for the pump rod and handle to freely slide from tubular body 18 as the texture material gun is tipped or moved during use. But for this locking of pump rod 50, the raising of the forward portion of the present invention texture material spray gun upwardly would allow pump rod 50 and handle 51 to slide to the extended position providing considerable annoyance and awkwardness in use. However, with slide lock 53 in the secured position shown, the movement of pump rod 50 is prevented despite tipping the spray gun to vertical angles.

Slide lock 53 is moved to the release position by simply forcing the slide lock in the direction indicated by arrow 58. The force must be sufficient to overcome the resilience of the plastic or nylon material or the like from which slide lock 53 is formed. As the applied force exceeds the gripping action of slide lock 53, aperture 55 is moved upon pump rod 50 allowing pump rod 50 to move freely for pumping. Following the pumping action, the user again moves slide lock 53 in the direction of arrow 57 to again secure pump rod 50 in its lock position. During the movement of slide lock 53, flexing or accommodated or enhanced by slot 54 and the resilience of the material from which slide lock 53 is fabricated.

FIG. 5 sets forth a partial section view of an alternate embodiment of the present invention. As described above, the present invention texture material spray gun includes a nozzle seat having a plurality of threads 75 formed thereon. Nozzle seat 42 further defines a bore 76 which allows the insertion of a mixture tube 68. In accordance with the alternate embodiment of FIG. 5, a nozzle 60 which is substantially similar to nozzle 14 described above, includes cooperating threads 67 which engage threads 75 of nozzle seat 42. An O-ring 74 is interposed between nozzle 60 and nozzle seat 42 to provide a seal. Nozzle 60 further defines a barrel portion 61 and a tapered portion 63. The latter terminates in a nozzle aperture 64. A chamber 66 is formed within the interior of nozzle barrel 61. A bore 75 sized in accordance with bore 76 extends forwardly from chamber 66.

Mixture tube 68 further supports a disperser 70 having an enlarged bead 71, a guide portion 80 and a plurality of angled apertures such as apertures 72 and 73. Disperser 70 is received within bores 65 and 76 in a sliding fit which facilitates movement back and forth of disperser 70 with respect to nozzle 60. Guide 80 cooperates with bore 76 to maintain the positioning and alignment of disperser 70 despite its movement back and forth. As is seen above, the interior of nozzle seat 42 including bore 76 is subjected to air pressure during spray gun operation. This air pressure moves the combination of mixing tube 68 and disperser 70 forwardly in the direction indicated by arrow 76. The extent of movement is determined by the position of nozzle 60 upon the threaded portion of nozzle seat 42. Thus, the position of nozzle 60 is adjustable by the user. This adjustment facilitates some control of the spray characteristics of the present invention spray gun. In addition, the compressed or pressurized air within bore 76 is able to flow forwardly past guide 80 due to the placement of a plurality of facets such as facet 81 within disperser 70. Thus, air flows past disperser 70 from bore 76 traversing facets 81, bead 71 and thereafter flows forwardly and inwardly through the angled apertures such as apertures 72 and 73. The use of guide 80 and facets 81 facilitates a precision fit within bore 76 for accurate spray action while simultaneously facilitating air travel past disperser 70 and into angled apertures 72 and 73. In the preferred fabrication of the present invention, a plurality of angled apertures similar to apertures 72 and 73 are equally spaced about disperser 70 which are not seen due to the view taken in FIG. 5. These apertures operate to disperse and swirl the spray material exiting nozzle 60.

Thus, as pressurized air flows through nozzle seat 42, past facets 81 and bead 71 and into apertures 72 and 73, a turbulent swirling air flow is produced within the interior of tapered portion 63. This occurs simultaneously with the travel of texture material upwardly and forwardly through mixing tube 68. As a result, within the tapered portion of the interior of tapered portion 63, a turbulent action is produced which acts upon the texture material and breaks up the texture material stream into a finally dispersed stream of texture material particles. This dispersal of texture material particles provides a substantially improved spray characteristic for the stream passing outwardly through nozzle aperture 64. The forwardly and inwardly angled apertures such as aperture 72 and 73 of disperser 70 substantially improve the swirling turbulent action of the texture material stream.

FIG. 6 sets forth a side elevation view of an alternate embodiment of the present invention texture material spray gun generally referenced by numeral 90. Texture material spray gun 90 utilized the above-described apparatus provided by substantial portions of material spray gun 10. By way of overview, it will be apparent from comparing FIG. 6 and FIG. 1 that the major difference between the embodiment shown in spray gun 10 and spray gun 90 are found in the removal of hand pump 12 and the utilization of compressed air operative gun handle 91. To facilitate this change and with temporary reference to FIG. 2, the structure of gun 10 with the exception of hand pump 12 is utilized in spray gun 90 by removing connector 62 along with check valve 24. O-ring 26 is retained and utilized in providing a seal between the remaining structures mated to complete spray gun 90.

More specifically, spray gun 90 includes chamber spray head 16 supporting a nozzle seat 42 and a nozzle 60. Nozzle 60 is shown in detail in FIG. 5. An O-ring seal 26 is interposed between chamber spray head 16 and nozzle seat 42. Chamber spray head 16 further includes a downwardly extending bezel member 22 which in turn is secured to a texture material supply vessel 20. While not seen in FIG. 6, it will be understood that in accordance with FIG. 5 and as is also better seen in FIG. 3, a material supply and mixture tube such as supply tube 44 extends downwardly from nozzle 60 through chamber spray head 16 and bezel member 22 into material supply 20. In accordance with the preferred fabrication of the present invention, the structure of nozzle 60 utilizes the apparatus shown in FIG. 5. However, it will be understood that the structure of nozzle 14 and mixture tube 44 may also be utilized.

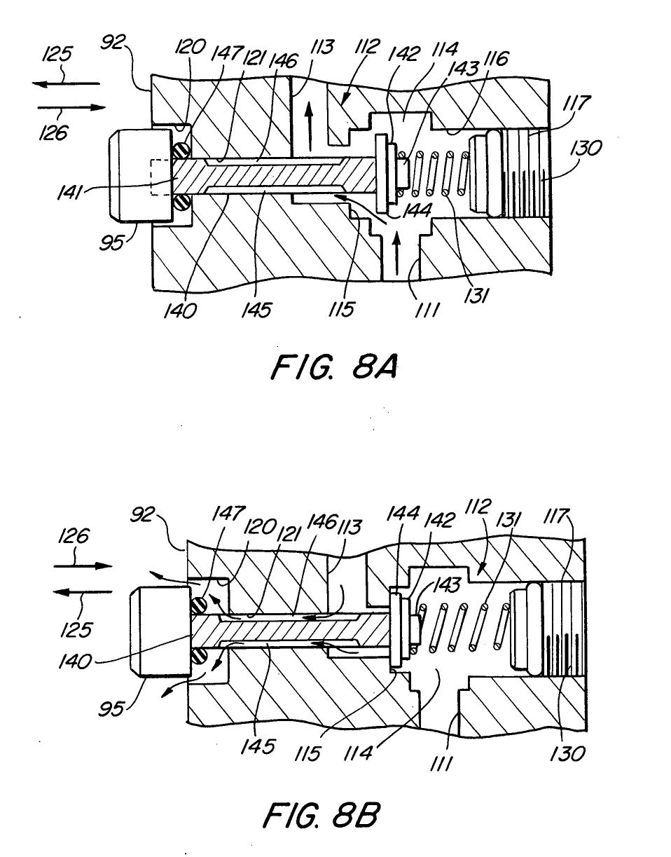

Gun handle 91 is formed of a rigid material such as aluminum or the like and includes a gun body 92 supporting a trigger button 95. Trigger button 95 is movable inwardly and outwardly with respect to gun body 92 in the manner shown in FIGS. 8A and 8B. Suffice it to note here that the actuation of trigger button 95 opens the air passage within gun body 92 allowing compressed air to flow through gun handle 91 into chamber spray head 16. An adapter 94 and a collar 93 cooperate to secure gun handle 91 to the supply side of chamber spray head 16. An O-ring 26 provides a seal between collar 93 and chamber spray head 16.

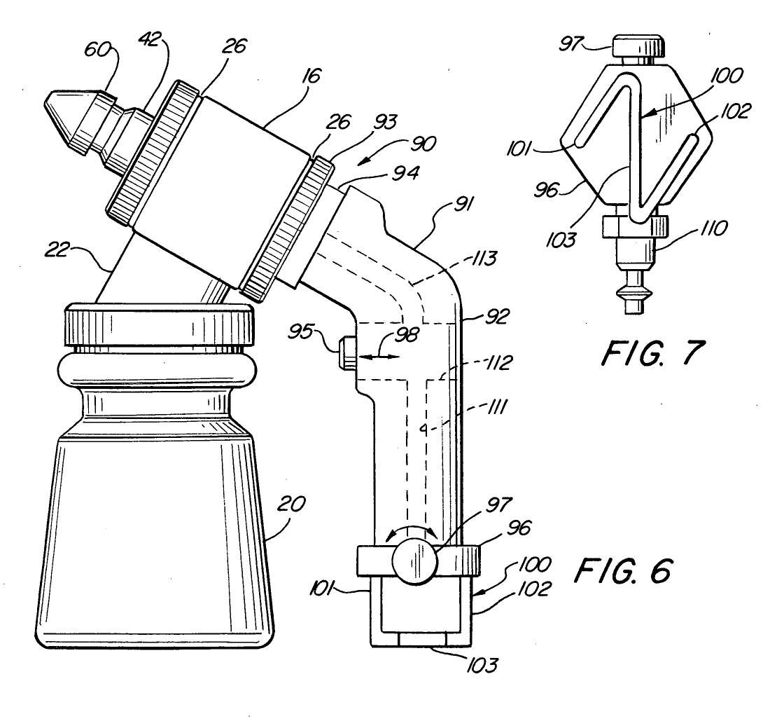

Gun handle 91 further includes a base 96 having a air flow restriction adjustment 97 and an air fitting 110 (seen in FIG. 7) supported thereon. Base 96 and restriction 97 are fabricated in accordance with conventional fabrication techniques. In accordance with an important aspect of the present invention, a wire support 100 extends downwardly from base 96 and provides a convenient support for gun handle 91. Wire support 100 includes a pair of downwardly extending vertical portions 101 and 102 together with a multiply curved lower portion 103 (better seen in FIG. 7). The purpose of wire support 100 is the provision of a supporting extension for gun handle 91 which positions lower portion 103 in a coplanar relationship with the bottom surface of texture material supply 20. In this fashion, texture material spray gun 90 may be conveniently rested upon any horizontal surface in a stable support which prevents tipping of the gun apparatus. To facilitate this use of wire support 100, air fitting 110 is oriented horizontally as seen in FIG. 7.

In operation, with air fitting 110 (seen in FIG. 7) coupled to a source of compressed air, an air flow is produced within air passage 111 flowing upwardly through gun body 92. Within trigger assembly 112 and in the manner described below in FIGS. 8A and 8B, the pressing of trigger button 95 inwardly releases air flow upwardly through the trigger assembly which passes further through air passage 113 and thereafter travels through adapter 94 into chamber spray head 16. The air pressure within chamber spray head 16 is directed into texture material supply 20 and forwardly through nozzle seat 42 and nozzle 60 as described above to produce material spray. Suffice it to note at this point that each time trigger button is pressed inwardly, trigger assembly 112 allows compressed air to flow upwardly through passage 113 and spray action takes place. Conversely, and as is also described below in greater detail, each time trigger button 95 is released, trigger assembly 112 closes preventing further air flow into passage 113 and spray action terminates.

In an important aspect of the present invention, trigger assembly 112 operates to provide a pressure bleed or pressure release for chamber spray head 16 and texture material supply 20 each time trigger button 95 is released terminating spray. The use of this pressure bleed is 0 extremely advantageous in employing a compressed air gun apparatus in texture material spray. In the absence of the air pressure bleed of trigger assembly 112, releasing trigger button 95 does not immediately terminate material spray. On the contrary, the residual pressure within texture material supply 20 and chamber spray head 16 continues to force texture material upwardly through the mixture tube and outwardly through nozzle 60. The problem is further complicated by the character of this material flow during the depressurizing of texture material supply 20. In essence, the continuing flow of texture material is unsuitable for spray application and rather presents an unusable messy dribbling of the texture material through nozzle 60. The use of the air pressure bleed of trigger assembly 112 avoids this problem by abruptly releasing and bleed off residual air pressure within material supply 20 and chamber spray head 16 thereby avoiding this undesired continued dribbling of material of nozzle 60.

FIG. 7 sets forth a bottom view of base 96 and wire support 100. Of importance to note in FIG. 7 is the positioning of air fitting 110 to facilitate the use of wire support 100. As described above, base 96 provides the supporting base for gun handle 91. As is also described, base 96 supports a restriction adjuster 97 and an air fitting 110. A wire support 100 includes a pair of downwardly extending portions 101 and 102 together with a multiply curved portion 103. The positioning of lower portion 103 in a coplanar relationship with the bottom surface material supply vessel 20 (seen in FIG. 6) facilitates the above mentioned stable support for resting gun 90 upon a convenient surface.

FIGS. 8A and 8B set forth partial section views of trigger assembly 112 in the open and closed positions respectively. By way of overview, the operation of trigger assembly 112 is controlled by the cooperation of a depressible button 95 supported within gun body 92 and a return spring 131 which, in the absence of pressure upon button 95, moves trigger assembly 112 to the closed or off position.

More specifically, FIG. 8A sets forth a partial section view of trigger assembly 112 within gun body 92 in the open or operating position. Gun body 92 defines an upwardly extending passage 111 which, as is shown in dash line representation in FIG. 6, forms an input of compressed air to trigger assembly 112. Gun body 92 further defines a passage 116 and a chamber 114. Chamber 114 further defines a valve seat 115 and communicates with an upwardly extending passage 113. As is also seen in FIG. 6, passage 113 forms the output passage of trigger assembly 112. Passage 116 defines internal threads 117 which receive a threaded plug 130. Gun body 92 further defines a trigger button recess 120 and a bore 121. Bore 121 extends between recess 120 and passage 113.

Trigger assembly 112 further includes a trigger shaft 140 having an outer end 141 secured to trigger button 95. Trigger shaft 140 extends through bore 121 of gun body 92 and terminates in an end 143 within chamber 114. A generally circular flange 142 is formed near end 113 upon trigger shaft 140. A resilient seal 144 is received upon trigger shaft 140 and is supported laterally by flange 142. A coil return spring 131 is received upon end 143 and extends into plug 130. An O-ring 147 is supported upon trigger shaft 140 near end 141. In accordance with an important aspect of the present invention, trigger shaft 140 defines a plurality of grooves 145 and 146 extending along trigger shaft 140.

In the open position shown in FIG. 8A, trigger button 95 has been depressed inwardly in the direction indicated by arrow 126 overcoming the force of spring 131 and moving trigger button 95 into recess 120. Simultaneously, the inward movement of button 95 drives trigger shaft 140 inwardly within bore 121 moving seal 144 away from seat 115. With seal 144 moved away from seat 115 an open air passage is formed allowing compressed air to flow upwardly through passage 111, into chamber 114, past seat 115, and upwardly through passage 113. With trigger button 95 depressed, the rear surface of button 95 forces O-ring 147 against recess 120 maintaining the seal between trigger shaft 140 and bore 121. As a result, air pressure within gun body 92 produces the upwardly directed air flow into passage 113 with little or no leakage outwardly through bore 121 and recess 120. This air flow continues so long as sufficient force is applied to button 95 to overcome the return force of spring 131. Once trigger button 95 is released however, the force of spring 131 rapidly moves the combined structure of trigger shaft 140, flange 142, seal 144, O-ring 147 and button 95 in the direction indicated by arrow 125. This motion continues until seal 144 is driven against seat 115 providing air passage closure. This closed configuration is shown in FIG. 8B below.

FIG. 8B sets forth the section view of trigger assembly 112 in the closed position resulting from release of trigger button 95. By way of overview, this closed position is maintained by the force of return spring 131. In further accordance with an important aspect of the present invention described below, it should be noted that the closed position assumed by trigger assembly 112 shown in FIG. 8B provides an air bleed path for releasing existing or residual pressure within the spray gun assembly.

More specifically, FIG. 8A sets forth a partial section view of trigger assembly 112 within gun body 92 in the open or operating position. Gun body 92 defines an upwardly extending passage 111 which, as is shown in dash line representation in FIG. 6, forms an input of compressed air to trigger assembly 112. Gun body 92 further defines a passage 116 and a chamber 114. Chamber 114 further defines a valve seat 115 and communicates with an upwardly extending passage 113. As is also seen in FIG. 6, passage 113 forms the output passage of trigger assembly 112. Passage 116 defines internal threads 117 which receive a threaded plug 130. Gun body 92 further defines a trigger button recess 120 and a bore 121. Bore 121 extends between recess 120 and passage 113.

Trigger assembly 112 further includes a trigger shaft 140 having an outer end 141 secured to trigger button 95. Trigger shaft 140 extends through bore 121 of gun body 92 and terminates in an end 143 within chamber 114. A generally circular flange 142 is formed near end 113 upon trigger shaft 140. A resilient seal 144 is received upon trigger shaft 140 and is supported laterally by flange 142. A coil return spring 131 is received upon end 143 and extends into plug 130. An O-ring 147 is supported upon trigger shaft 140 near end 141. In accordance with an important aspect of the present invention, trigger shaft 140 defines a plurality of grooves 145 and 146 extending along trigger shaft 140.

As mentioned above, the movement of trigger shaft 140 together with associated components such as button 95, seal 144 and flange 142 in response to the force of spring 131 provides and maintains closure of the air passage formed between passage 111, chamber 114 and passage 113. This of course terminates the flow of pressurized air from the compressed air source to which gun body 92 is coupled. Of substantial importance in accordance with the present invention however, is the further air bleed which takes place as trigger button 95 is released allowing trigger assembly 112 to move to the closed position of FIG. 5B. This air bleed is best understood by considering FIG. 8B at the moment when air flow closure occurs as seal 144 is driven against seat 115. At this moment, air pressure exists within chamber 114 and input air passage 111. Of greater importance however, is the continued existence of air pressure within the remainder of spray gun 90 (seen in FIG. 1) which exists within texture material supply 20 and chamber spray head 16 as well as passage 113. It is this residual or continuing pressure which provides the above-described dribbling or low velocity discharge of texture material.

In accordance with the present invention however, the air pressure within material supply 20, spray head 16 and passage 113 is provided with an air bleed path the moment trigger shaft 140 begins moving toward the closed position shown in FIG. 8B. As trigger shaft 140 moves outwardly in the direction indicated by arrow 125, the outer ends of grooves 145 and 146 moves beyond bore 121 into recess 120. The instant this movement takes place, an air flow path is provided through bore 121 via grooves 145 and 146. This air flow path extends outwardly from recess 120 to disperse the air pressure within the spray gun. While not seen in FIG. 8B due to the section view therein, it is anticipated that the preferred fabrication of the present invention utilizes a significant number of air bleed grooves spaced about trigger shaft 140. It has been found that three or four air bleed grooves provide substantial air flow and allow a rapid depressurization of the spray gun. This air flow continues until the pressure within the spray gun has reached atmospheric pressure at which time no material is forced outwardly from nozzle 60. Because a plurality of air bleed grooves of substantial size are utilized, the pressure release is extremely rapid and appears to the user to be virtually instantaneous in that material flow stops virtually immediately after trigger 95 is released.

The resumption of material spray is instituted as the user again presses trigger button 95 inwardly in the direction indicated by arrow 26 returning the trigger assembly to the configuration shown in FIG. 8A. It should be noted that O-ring seal 147 is carried along with end 141 of trigger shaft 140 as trigger button 95 moves inwardly and outwardly. This facilitates both the opening of air bleed pathways when the trigger button is released and the effective seal of leakage between trigger shaft 140 and bore 121 when trigger button 95 is pressed.

What has been shown is an improved texture material spray gun which is fabricated in a manner which provides for complete disassembly and cleaning in an easy and cost effective manner. The present invention spray gun further provides an alternative hand pump or compressed air gun cooperating spray apparatus which effectively breaks up the texture material spray into a finally dispersed more effective and desirable spray pattern. The compressed air gun operative embodiment of the present invention shown overcomes problems of residual air pressure material discharge during trigger on to off cycling and provides virtually instant material flow termination upon trigger release. The entire apparatus is easy to handle and extremely effective during use.

That which is claimed is:

1. A drywall texture gun, comprising:
a chamber spray head, having a one-way check valve installed at a first end thereof to allow a compressed air flowing therein;
a nozzle, connected to a second end of the chamber spray head; and
a supply tube, extending across the chamber spray head with an inlet entering a texture supply and an outlet entering the nozzle, wherein;
the outlet is restricted in the nozzle with an adjustable space to reciprocate responsive to the compressed air;
the outlet is so structured that the compressed air is introduced from the chamber spray head to adjust a pattern of a texture flowing therethrough; and
the inlet is so structured that the compressed air is able to flow from the chamber spray head to the texture supply to drive the texture into the supply tube.

2. The drywall texture gun according to claim 1, further comprising a hollow body connected to the first end of the chamber spray head, wherein the hollow body is connected to a compressed air source.

3. The drywall texture according to claim 1, further comprising a nozzle seat inserted between the nozzle and the chamber spray head.

4. The drywall texture gun according to claim 3, wherein the nozzle is adjustably mounted on the nozzle seat.

5. The drywall texture gun according to claim 3, wherein the tube has a dimension smaller than an outside diameter of the nozzle seat, such that compressed air can flow from the chamber spray head to the nozzle.

6. The drywall texture gun according to claim 1, wherein the chamber spray head has an opening at a sidewall thereof allowing the supply tube to extend to the texture supply.

7. The drywall texture according to claim 6, wherein the opening is larger than a dimension of the supply tube, such that the compressed air can flow from the chamber spray head into the texture supply.

8. The drywall texture according to claim 1, wherein the outlet has a protruded structure at a perimeter thereof to restrict the outlet in the nozzle.

9. The drywall texture according to claim 1, wherein the outlet has at least one hole at a perimeter thereof, such that the compressed air flowing from the chamber spray head can enter the supply tube at the outlet to break up the texture therein.

10. A texture gun, comprising:
a hollow module, through which compression pressure is supplied,
a nozzle module, through which a texture is sprayed;
a chamber spray head module, through which the compression pressure is translated from the hollow module to texture supply, of which the texture driven by the compression pressure is transported to the nozzle module;
a one-way check valve module, to prevent the texture from flowing into the hollow modular; and
a texture channel, through which the texture is transported from the texture supply to the nozzle, wherein an outlet of the texture channel restricted in the nozzle module provides a path for the compression pressure flowing from the chamber spray head into the texture channel at the outlet, such that the texture is broken up before being sprayed from the nozzle module.

11. A texture gun comprising:
a texture material supply for receiving and retaining a quantity of texture material;
a chamber spray head coupled to said texture material supply having a compressed air input;
a nozzle supported by said chamber spray head having a nozzle chamber and nozzle aperture;
a supply tube extending from said nozzle to said texture material supply;
a compressed air gun having means for coupling to a source of compressed air, an input passage coupled to said means for coupling, and an output passage coupled to said chamber spray head; and
a trigger unit interposed between said input and output passages and operable in an open and closed state,
said trigger unit including a spray gun air bleed operable when said trigger unit is switched from said open state to said closed state to release existing air pressure in said nozzle, said chamber spray head, said texture material supply and said output passage.

12. The texture gun set forth in claim 11 wherein said trigger unit includes:
an internal chamber formed in said compressed air gun in communication with said input and output passages and having a valve seal therebetween;
a trigger shaft having a seal, an inner end and an outer end said trigger shaft being movable between a first position closing said seal against said valve seat and a second position opening said seal away from said valve seal;
a spring urging said trigger shaft toward said first position; and
an air bleed path formed in said trigger shaft for allowing air flow from said output passage to the exterior of said compressed air gun when said trigger shaft is in said first position.

13. The texture gun set forth in claim 12 wherein said compressed air gun defines a bore within which said trigger shaft is slidable and wherein said air bleed path include one or more grooves formed in said trigger shaft said grooves extending between said output passage and beyond said bore when said trigger shaft is in said first position.

14. The texture gun set forth in claim 13 wherein said trigger unit includes a trigger button supported on said outer end and wherein said bore terminates in an outer surface, said trigger unit further including a resilient seal carried by said trigger shaft between said trigger button and said outer surface.

15. The texture gun set forth in claim 11 wherein said nozzle defines a nozzle bore and wherein said supply tube includes an upper end passing through said nozzle bore into said nozzle chamber and having a disperser supported upon said upper end within said nozzle chamber.

16. The texture gun set forth in claim 15 wherein said disperser includes a guide fitted within said nozzle bore, one or more facets in said guide and a plurality of dispersing apertures whereby air flows past said one or more facets and through said disperser apertures to break up texture material flowing into said nozzle chamber.

17. The texture gun set forth in claim 16 wherein said disperser includes an enlarged bead captivating said disperser within said nozzle chamber.
